(19) United States
(12) Patent Application Publication
(10) Pub. No.: US 2009/0248601 A1
(43) Pub. Date: Oct. 1, 2009

(54) EXPLOITING DOUBLE RESOLUTIONS FOR PROOF OPTIMIZATIONS

(75) Inventors: Omer Bar-Ilan, Haifa (IL); Oded Fuhrmann, Ya'Akov (IL); Shlomo Hoory, Haifa (IL); Ohad Shacham, Kfar Monash (IL)

Correspondence Address: KING & SPALDING, 1180 PEACHTREE ST., ATLANTA, GA, 30309, US

(73) Assignee: International Business Machines Corporation, Armonk, NY (US)

(21) Appl. No.: 12/059,152

(22) Filed: Mar. 31, 2008

(51) Int. Cl. G06N 5/02

(52) U.S. Cl. 706/46

(57) ABSTRACT

A method for simplifying resolution proofs in DAG format where each leaf node represents a clause and each internal node represents a resolution between its children includes representing a SAT proof as a stripped proof, analyzing pivots to identify redundant resolutions, and constructing a simplified proof without the redundant resolutions.

### BACKGROUND OF THE INVENTION

1. Field of the Invention

This invention relates to the simplification of satisfiability problem proofs using double pivot reduction.

2. Description of Background

Satisfiability (“SAT”) problems are decision problems, i.e., given an expression, determine if there is some assignment of variables that make the entire expression true. SAT problems have applications in a variety of areas including computer science, automation, and artificial intelligence.

A well known algorithm for solving SAT problems is the Davis-Putnam-Logemann-Loveland algorithm (“DPLL”). DPLL-based SAT solvers progress by implicitly applying binary resolution. They generate resolution proofs that are useful for a variety of purposes in formal verification and elsewhere including: extracting an unsatisfiable core in case the formula is unsatisfiable, extracting an interpolant, and detecting clauses that can be reused in an incremental satisfiability setting such as the one used in Bounded Model-Checking.

SAT problem solutions are typically presented as proofs and can be presented in a form called Directed Acyclic Graph (“DAG”). When a prior art SAT solver produces a proof, it can contain redundant resolutions. While there are methods such as Run till fix, Core Trimmer and Proof Tightening that are known in the art as methods of simplifying proofs, the prior art does not disclose a method for simplifying proofs by identifying and removing redundant resolutions.

### SUMMARY OF THE INVENTION

The shortcomings of the prior art are overcome and additional advantages are provided through the use of a method for simplifying resolution proofs in DAG format where each leaf node represents a clause and each internal node represents a resolution between its children by representing a SAT proof as a stripped proof, analyzing pivots to identify redundant resolutions, and constructing a simplified proof without the redundant resolutions.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, SAT proofs are simplified This simplification results in a savings of processing time and cost in use of the simplified proof in place of the original proof.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows an illustrative example in accordance with the invention;

FIG. 2 shows an illustrative example of a stripped proof;

FIG. 3 shows an illustrative example of a stripped pivot proof;

FIG. 4 shows an illustrative example of a reduced proof;

FIG. 5 shows an illustrative example of a reconstructed proof;

FIG. 6 shows an illustrative example of a final proof.

The detailed description explains the preferred embodiments of the invention, together with advantages and features, by way of example with reference to the drawings.

### DETAILED DESCRIPTION OF THE INVENTION

The invention herein involves simplification of SAT proofs using a method called double pivot reduction. Double pivot reduction relies on the exploitation of the double pivot phenomena. When two resolutions occur on the same branch of a proof in a tree form, the bottom one, i.e., the one closest to the leafs is redundant. This bottom resolution can be removed from the proof and thus enable its simplification.

In a DAG presentation, let node n1 rule node n2 if every path from root to n2 passes through n1. Given a DAG form of a SAT proof, the preferred embodiment identifies double resolutions on the same pivot where one is ruling the other and removes the bottom resolution.

It is well known in the art that some reordering of resolutions in a SAT proof is possible. A preferred embodiment involves reordering to increase the double pivot effect and using it for further simplification.

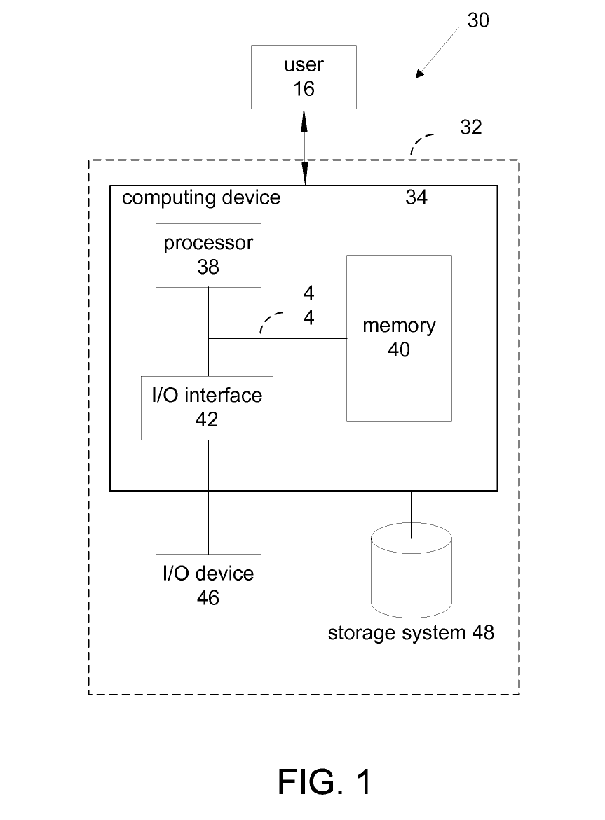

With reference to the accompanying drawings, FIG. 1 shows an illustrative environment 30 for managing the processes in accordance with the invention. To this extent, the environment 30 includes a computer infrastructure 32 that can perform the processes described herein. In particular, the computer infrastructure 32 is shown including a computing device 34 operable to perform the processes described herein.

The computing device 34 is shown including a processor 38, a memory 40, an input/output (I/O) interface 42, and a bus 44. Further, the computing device 34 is shown in communication with an external I/O device/resource 46 and a storage system 48. As is known in the art, in general, the processor 38 executes computer program code, which is stored in memory 40 and/or storage system 48. While executing computer program code, the processor 38 can read and/or write data, such as the range boundary 50, to/from memory 40, storage system 48, and/or I/O interface 42. The bus 44 provides a communications link between each of the components in the computing device 34. The I/O device 46 can comprise any device that enables an individual to interact with the computing device 34 or any device that enables the computing device 34 to communicate with one or more other computing devices using any type of communications link.

The computing device 34 can comprise any general purpose computing article of manufacture capable of executing computer program code installed thereon (e.g., a personal computer, server, handheld device, etc.). However, it is understood that the computing device 34 is only representative of various possible equivalent computing devices that may perform the processes described herein. Similarly, the computer infrastructure 32 is only illustrative of various types of computer infrastructures for implementing the invention. For example, in one embodiment, the computer infrastructure 32 comprises two or more computing devices (e.g., a server cluster) that communicate over any type of communications link, such as a network, a shared memory, or the like, to perform the process described herein.

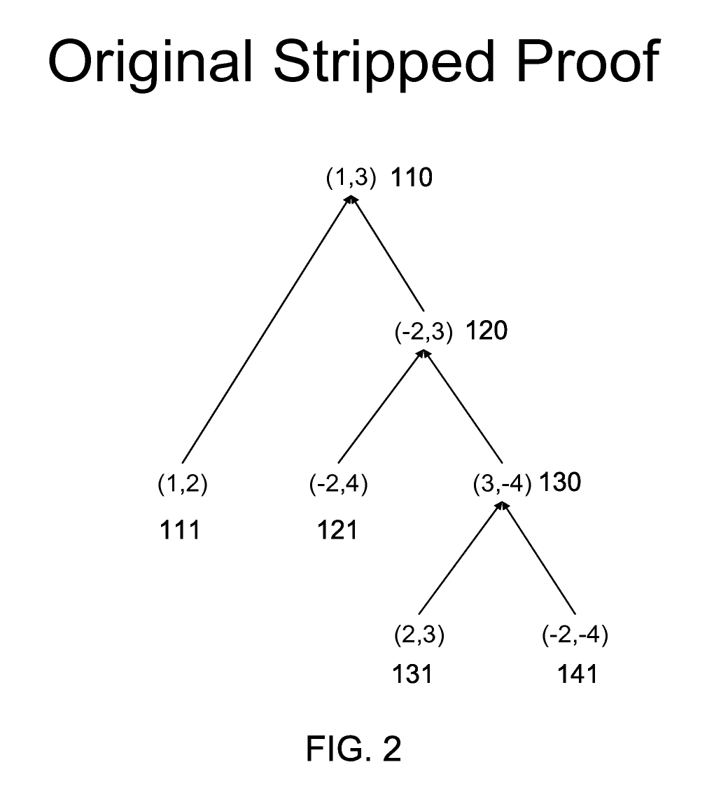

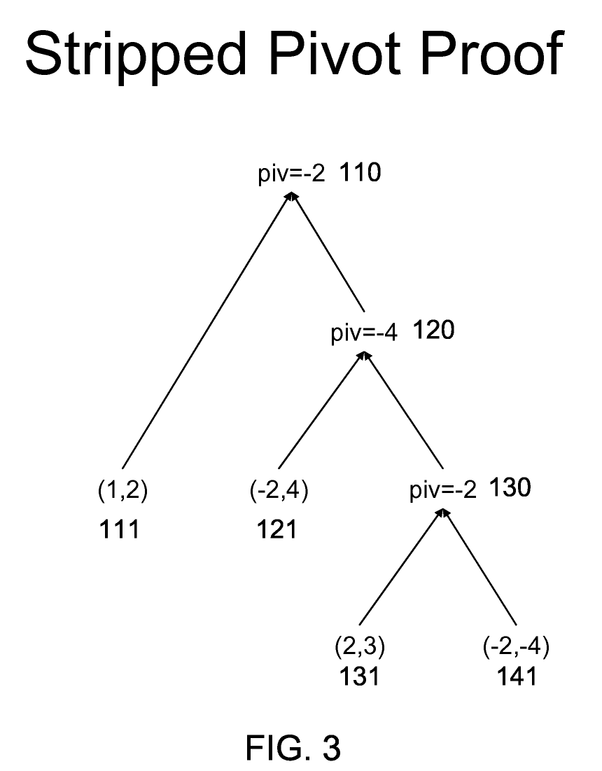

A preferred embodiment is disclosed in the example provided in FIGS. 2-6 and the pseudo code contained herein. FIG. 2 is an original “stripped proof.” A stripped proof in this embodiment is a DAG where each node leaf 111, 121, 131, 141 represents a clause and every non-leaf node 110, 120, 130 has either one or two children. FIG. 3 depicts the “stripped pivot proof” version of the original proof shown in FIG. 2. The stripped pivot proof is a stripped proof where each internal node 110, 120, 130 with two children is annotated by a literal pivot.

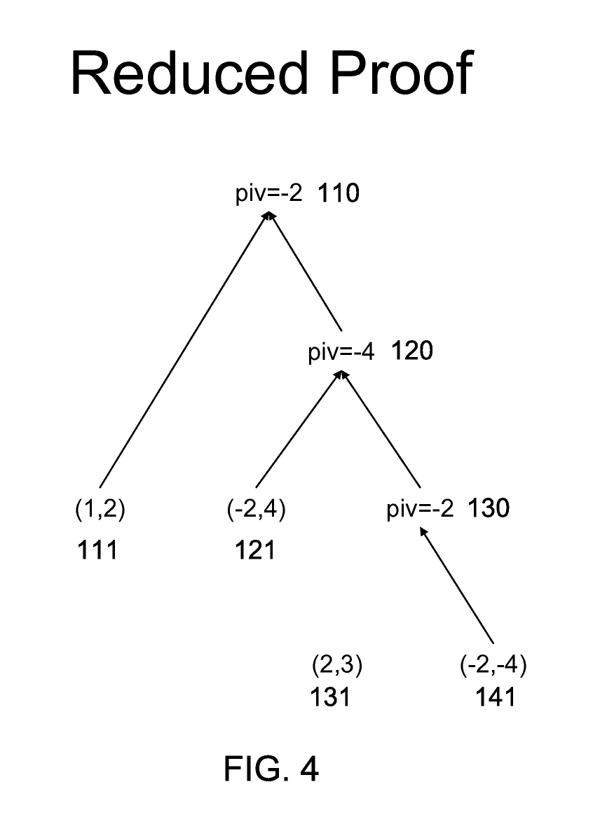

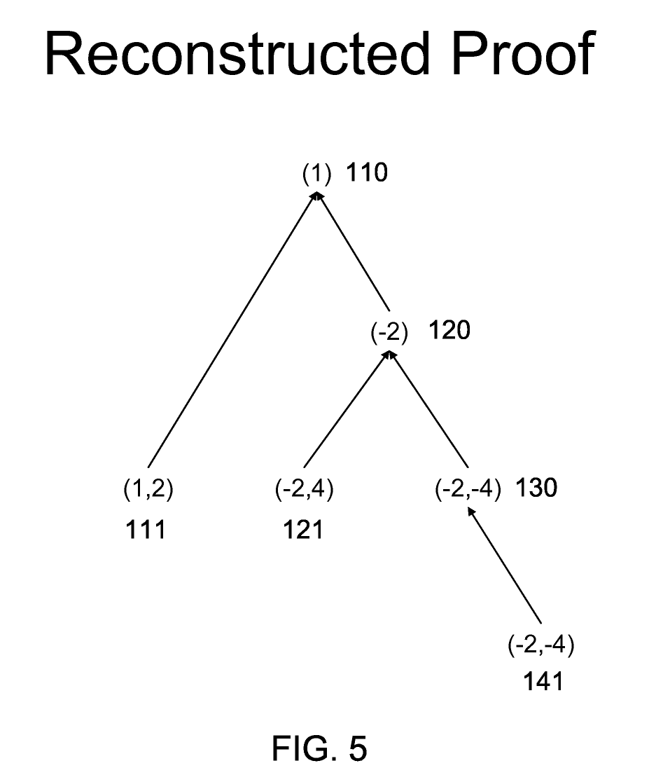

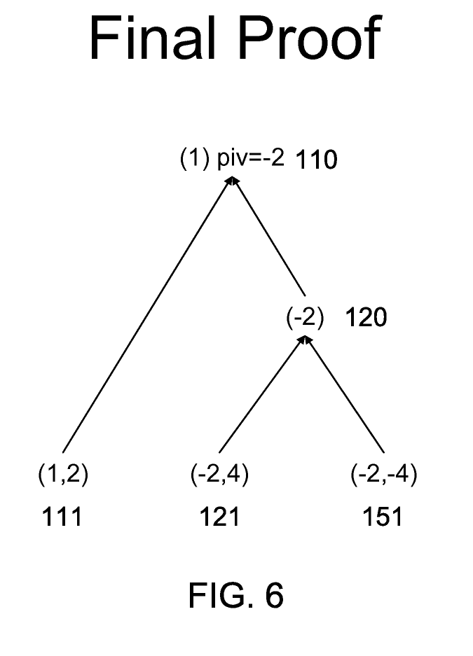

FIG. 4 depicts the proof after reduction, where one leg representing a redundant resolution leading to leaf node 131 is removed according to the preferred embodiment. FIG. 5 depicts the reconstructed proof after it is reconstructed without the removed leaf 131. FIG. 6 depicts the final proof after further manipulation to simplify the DAG by substituting node 151 in place of redundant resolutions represented by nodes 130, 131 and 141.

The following pseudo code provides a preferred implementation of the claimed method.

### Notation:

res (C_{L},C_{R}) is the resolution clause of C_{L} and C_{R}
piv (C_{L}, C_{R}) is the pivot lit, it is assumed that piv (C_{L}, C_{R}) is included in
C_{L} and − piv (C_{L}, C_{R}) is included in C_{R}.

### Definition Proof

A proof is a directed acyclic graph (DAG) P with a single root, P.root, where each node represents a clause n.C. The single root represents the clause C_{Conclusion}. For every node n the following holds:

| | |
|---|---|
| 1. | n is a leaf of the graph. |
| 2. | n has only one child, n.L. In this case n.C is equal to n.L.C. |
| 3. | The node has exactly two children representing the clauses CL and |
| | CR. In this case n.c=res(n.L.C, n.R.C) |

Definition (Stripped Proof) A stripped proof is a directed acyclic graph (DAG) with a single root where each leaf node represents a clause. Every non leaf node has either one or two children.
Defenition (Stripped Pivot Proof). A stripped pivot proof is a stripped proof where each internal node n with 2 children is annotated by a literal pivot n. piv.
Algorithm stripp

Input: A proof P

Output: A striped proof P′

| | |
|---|---|
| 1. | for each node n in P |
| 2. | add a node n’ to P’ |
| 3. | for each node n in P |
| 4. | if n is a leaf of P |
| 5. | n’.C := n.C |
| 6. | else if n has two children |
| 7. | n’.piv = piv (n.L.C, n.R.C) |

Comment: For each Proof P Stripping (P) is a stripped Proof
Algorithm reconstruct

Input: A stripped pivot proof P

Output: P holds a proof

mark all nodes of P as unvisited

recursiveReconsturct (P, root (P))

Algorithm recursiveReconsturct

Input: Stripped Proof P and node n

Output: P such that the sub proof starting at n is a proof of n.c.

| | |
|---|---|
| 1. | if n visited |
| 2. | return |
| 3. | mark n as visited |
| 4. | if n is a leaf |
| 5. | return |
| 6. | if n has a single child n.L |
| 7. | n.C = n.L.C |
| 8. | else |
| 9. | recursiveReconsturct (P,n.L) |
| 10. | recursiveReconsturct (P,n.R) |
| 11. | if piv is in N.C.L and −piv is in N.C.R |
| 12. | n.C = res( n.L.C,n.R.C) |
| 13. | else if (piv is in n.L.c and not in n.R.C) |
| 14. | n.C = n.R.C |
| 15. | n.L = nill |
| 16. | else if (−piv is in n.R.c and not in n.L.C) |
| 17. | n.C = n.L.C |
| 18. | n.R = nill |
| 19. | else |
| 20. | heuristically choose side from L or R |
| 21. | n.C = n.side.C |
| 22. | n.otherSide = nill |
| 23. | return |

Comment for each Proof P reconstruct (stripp (P))==P
Definition clause partial order

C1≧C2 iff all lits of C1 are included in C2

Definition Proof partial order

```
P1 ≧ P2 iff
  1.  leafs of P1   l̅eafs of P2
  2.  P1.root ≧ P2.root
```

Algorithm: doublePivotReduction
input: a stripped proof P
output: a (“stronger”, see comment below) stripped proof P

| | |
|---|---|
| 1. | doublePivotRecReduction (P.root,{ }) |
| 2. | return P |

doublePivotRecReduction (n, removableLits)

| | |
|---|---|
| 1. | if n.visited |
| 2. | return |
| 3. | n.visited=true |
| 4. | if leaf |
| 5. | return |
| 6. | if (n has more then one parent) |
| 7. | removableLits = { } |
| 8. | if (piv in n.L.c and −piv in n.R.c ) |
| 9. | doublePivotRecReduction(nL,removableLits U {−piv}) |
| 10. | doublePivotRecReduction(nR,removableLits U {piv}) |
| 11. | else if (piv in n.L.c and −piv not in n.R.c U {−piv}) |
| 12. | n.L = nill |
| 13. | doublePivotRecReduction(n1,removableLits); |
| 14. | else if (piv not in n.L.c and −piv in n.R.c ) |
| 15. | n.R = nill |
| 16. | doublePivotRecReduction(nr,removableLits U {piv}); |
| 17. | else |
| 18. | choose huristicly a side from L and R |
| 19. | n.sideNotChosen = nill |
| 20. | doublePivotRecReduction(n.side,removableLits); |

comment: reconstruct (doublePivotReduction (stripp (P))==P

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A computer-implemented method for reducing computational time needed to process resolution proofs by simplifying resolution proofs in directed acyclic graph (DAG) format, wherein each leaf node represents a clause and each internal node represents a resolution between its children, and wherein the computer-implemented method is implemented by a computing device that comprises computer program code and a processor that executes the computer program code, the method comprising the steps of:
representing, by the computing device, a satisfiability proof as a stripped proof, wherein the stripped proof comprises a resolution proof in DAG format wherein each internal node comprises either one or two children;
analyzing, by the computing device, pivots of the stripped proof to determine if any of the pivots of the stripped proof comprises redundant resolutions;
based on a determination that a pivot comprises redundant resolutions, removing, by the computing device, the redundant resolution closest to the leaf node of the pivot; and
constructing, by the computing device, a simplified proof the simplified proof comprising the stripped proof without the removed redundant resolution.
